(19) United States
(12) Patent Application Publication
(10) Pub. No.: US 2018/0286345 A1
(43) Pub. Date: Oct. 4, 2018

(54) ADAPTIVE SYNC SUPPORT FOR EMBEDDED DISPLAY

(71) Applicant: Intel Corporation, Santa Clara, CA (US)

(72) Inventors: Yiting Lee, Taipei (TW); Mathangi Srinivasan, Bengaluru (IN); Suketu J. Shah, San Jose, CA (US); Sameer KP, Bangalore (IN); Curly Tsao, Taipei (TW)

(73) Assignee: Intel Corporation, Santa Clara, CA (US)

(21) Appl. No.: 15/472,900

(22) Filed: Mar. 29, 2017

(51) Int. Cl. G09G 5/00

(52) U.S. Cl. CPC G09G 5/006; G09G 2310/08; G09G 2330/021; G09G 2340/0435

(57) ABSTRACT

Methods for controlling refresh rate during panel self-refresh 2 (PSR2), are described. Those methods and associated devices may include sending, via a source interface controller enabled for PSR2, a display port configuration data (DPCD) value of high, a data transfer request packet to include a low refresh rate target value of a display device; receiving, via the sink interface controller, the DPCD high value; and entering, via the sink interface controller, a low refresh rate at target values when the source interface controller enters static or sleep mode, and wherein the refresh rate is dynamically controlled during PSR2.

### BACKGROUND

Display modules/technologies used in smartphones, tablets, and PC platforms, among others, are increasing in both size and resolution. Because such display modules typically rely on AC power, the power consumed by displays rises proportionally as display resolution increases. Thus, device displays are increasingly a main source of power consumption in modern day computing.

### BRIEF DESCRIPTION OF THE DRAWINGS

While the specification concludes with claims particularly pointing out and distinctly claiming certain embodiments, the advantages of these embodiments can be more readily ascertained from the following description when read in conjunction with the accompanying drawings in which:

FIG. 1 is a block diagram illustrating an example computing device that can be used to refresh a display device.

FIG. 2 is a block diagram illustrating an example system that can be used to refresh a display device.

FIG. 3 is a communication diagram of an example system that can be used for adaptive sync for PSR2 enabled at LRR.

FIG. 4 represents a progress flow diagram according to embodiments.

FIG. 5 represents a process flow diagram according to embodiments.

FIG. 6 is a process flow diagram illustrating an example method according to embodiments.

FIG. 7 is a process flow diagram illustrating an example method according to embodiments.

FIG. 8 is a block diagram showing computer readable media that store code for discovery of devices.

### DETAILED DESCRIPTION

In the following detailed description, reference is made to the accompanying drawings that show, by way of illustration, specific embodiments in which the methods and structures may be practiced. These embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments.

The following detailed description is, therefore, not to be taken in a limiting sense, and the scope of the embodiments is defined only by the appended claims, appropriately interpreted, along with the full range of equivalents to which the claims are entitled. In the drawings, like numerals may refer to the same or similar functionality throughout the several views.

As described above, the display electronics power rises proportionally as display resolution increases. One method of reducing the amount of power used by an electronic display is to reduce the refresh rate of the display. Computer monitors normally refresh their displays at a fixed frame rate. In gaming applications, for example, a computer's central processing unit (CPU) or graphics processing unit (GPU) output frame rate will vary according to the rendering complexity of the image. If a display's refresh rate and a computer's render rate are not synchronized, visual artifacts, such as tearing or stuttering—can be seen by the user. Moreover, some displays may use dynamic refresh rate change adapting to a display screen pattern or data profile in order to reduce power consumption. For example, power saving features may change the refresh rate or even use a refresh mechanism internal to a panel. Techniques for communicating and controlling the refresh rate between a CPU display controller during a panel self refresh, and a display device are provided herein. The techniques allow changing refresh rate using a sink interface module. Thus, techniques described herein may provide energy savings while preventing tearing failure. In some examples, the techniques may be used to reduce power used in mobile/wireless displays. However, the techniques may also be applied to wired digital display interfaces (wired DDIs).

Some embodiments may be implemented in one or a combination of hardware, firmware, and software. Some embodiments may also be implemented as instructions stored on a computer readable medium, which may be read and executed by a computing platform to perform the operations described herein. A computer readable medium may include any mechanism for storing or transmitting information in a form readable by a machine, e.g., a computer. For example, a computer readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments”, or “other embodiments” means that a particular feature, structure, or characteristic described in connection with the embodiments is included in at least some embodiments, but not necessarily all embodiments, of the inventions. The various appearances of “an embodiment”, “one embodiment or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can”, or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

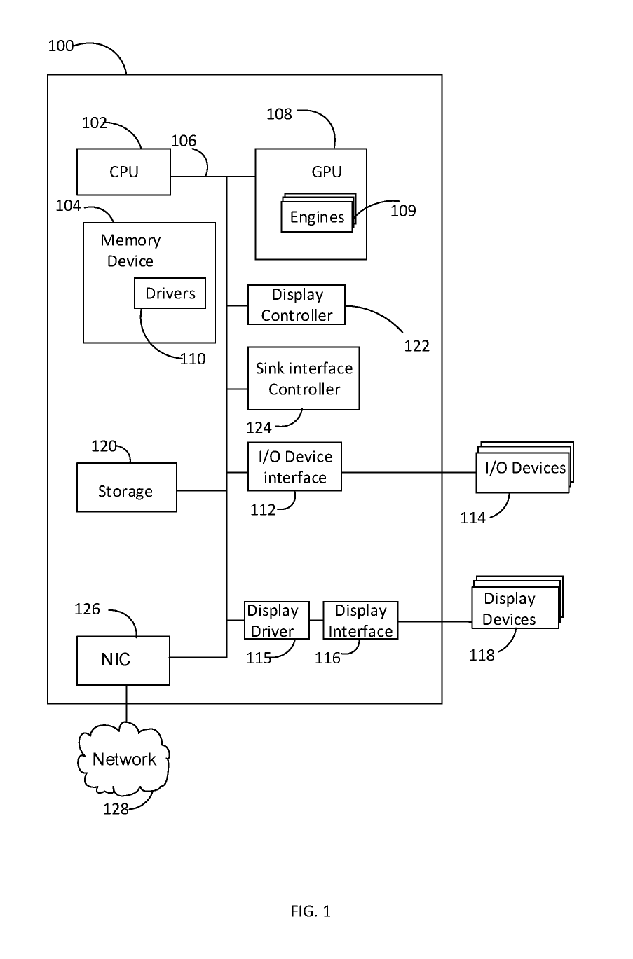

FIG. 1 is a block diagram illustrating an example computing device that can be used as a node for discovery of devices. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU 102 may be coupled to the memory device 104 by a bus 106. Additionally, the CPU 102 can be a single core processor, a multi-core processor, a computing cluster, or any number of other configurations. Furthermore, the computing device 100 may include more than one CPU 102. The memory device 104 can include random access memory (RAM), read only memory (ROM), flash memory, or any other suitable memory systems. For example, the memory device 104 may include dynamic random access memory (DRAM).

The computing device 100 may also include a graphics processing unit (GPU) 108. As shown, the CPU 102 may be coupled through the bus 106 to the GPU 108. In some cases, the GPU 108 is embedded in the CPU 102. In other cases, the GPU 108 may be a discrete component relative to the CPU 102. The GPU 108 may include a cache, and can be configured to perform any number of graphics operations within the computing device 100. The GPU 108 may be configured to perform any number of graphics operations within the computing device 100. For example, the GPU 108 may be configured to render or manipulate graphics images, graphics frames, videos, or the like, to be displayed to a user of the computing device 100. Displaying image data may be carried out by one or more engines 109 of the GPU 108, a display driver 115, a display interface 116, and the like.

The memory device 104 can include random access memory (RAM), read only memory (ROM), flash memory, or any other suitable memory systems. For example, the memory device 104 may include dynamic random access memory (DRAM). The memory device 104 may include device drivers 110 that are configured to execute the instructions for device discovery. The device drivers 110 may be software, an application program, application code, or the like.

The CPU 102 may also be connected through the bus 106 to an input/output (I/O) device interface 112 configured to connect the computing device 100 to one or more I/O devices 114. The I/O devices 114 may include, for example, a keyboard and a pointing device, wherein the pointing device may include a touchpad or a touchscreen, among others. The I/O devices 114 may be built-in components of the computing device 100, or may be devices that are externally connected to the computing device 100. In some examples, the memory 104 may be communicatively coupled to I/O devices 114 through direct memory access (DMA).

The CPU 102 may also be linked through the bus 106 to a display interface 116 configured to connect the computing device 100 to a display device 118. The display device 118 may include a display screen that is a built-in component of the computing device 100. The display device 118 may also include a computer monitor, television, or projector, among others, that is internal to or externally connected to the computing device 100. In some examples, the display device 118 includes a timing controller that can include an internal clock oscillator. The oscillator can be used to manage display device refresh with video data. In some examples, the display device 118 can also include a sink interface controller that includes a FIFO to receive video data to be displayed. For example, the FIFO can be of any suitable size, such as anywhere from four kilobytes to ten megabytes in size or more.

The computing device also includes a storage device 120. The storage device 120 is a physical memory such as a hard drive, an optical drive, a thumbdrive, an array of drives, or any combinations thereof. The storage device 120 may also include remote storage drives.

The computing device 100 may also include a network interface controller (NIC) 126. The NIC 126 may be configured to connect the computing device 100 through the bus 106 to a network 128. The network 128 may be a wide area network (WAN), local area network (LAN), or the Internet, among others. In some examples, the device may communicate with other devices through a wireless technology. For example, Bluetooth® or similar technology may be used to connect with other devices.

The computing device 100 may also include a display controller 122. The display controller 122 may be implemented as logic, at least partially comprising hardware logic. In other cases, the display controller 122 may be implemented as a portion of software stored in the storage device 104, as software or firmware instructions of the display driver 115, the display interface 116, the engines 109 of the GPU 108, the CPU 102, any other suitable controller, or any combination thereof.

In yet other cases, the display controller 122 may be implemented as electronic logic, at least partially comprising hardware logic, to be carried out by electronic circuitry, circuitry to be carried out by an integrated circuit, and the like. The display controller 122 may be configured to operate independently, in parallel, distributed, or as a part of a broader process. In yet other cases, the display controller 122 may be implemented as a combination of software, firmware, hardware logic, and the like. In some examples, the display controller 122 may be used to receive a video transfer request packet and send an acknowledge response packet to a sink interface controller 124.

In some examples, the sink interface controller 124 may be included inside display device 118. The display controller 122 can send the video burst and receive a second acknowledge response packet from the sink interface controller 124. The sink interface controller 124 may be used to send a video transfer request packet to the display controller 122. The sink interface module 124 can receive an acknowledge response and video burst in response to the request packet. The sink interface controller 124 can also send an acknowledge response to the video burst.

In some examples, a video burst includes video data to be sent at a full speed of a physical layer link of the system. In some examples, the sink interface controller 124 may include a First In, First Out (FIFO) data buffer, the FIFO to receive the video burst from the display controller 122 and send it to a display device 118. In some examples, the sink interface controller 124 may include a line buffer or an output laches. For example, the line buffer or output laches may receive the video burst from the display controller 122 and send it to a display device. In some examples, the sink interface module may be a sink interface controller. The display controller 122 may include a source interface controller of a central processing unit (CPU).

The block diagram of FIG. 1 is not intended to indicate that the computing device 100 is to include all of the components shown in FIG. 1. Rather, the computing system 100 can include fewer or additional components not illustrated in FIG. 1, such as sensors, power management integrated circuits, additional network interfaces, and the like. The computing device 100 may include any number of additional components not shown in FIG. 1, depending on the details of the specific implementation. Furthermore, any of the functionalities of the CPU 102 may be partially, or entirely, implemented in hardware and/or in a processor. For example, the functionality of the display controller 122 and the sink interface controller 124 may be implemented with an application specific integrated circuit, in logic implemented in a processor, in logic implemented in a specialized graphics processing unit, or in any other device.

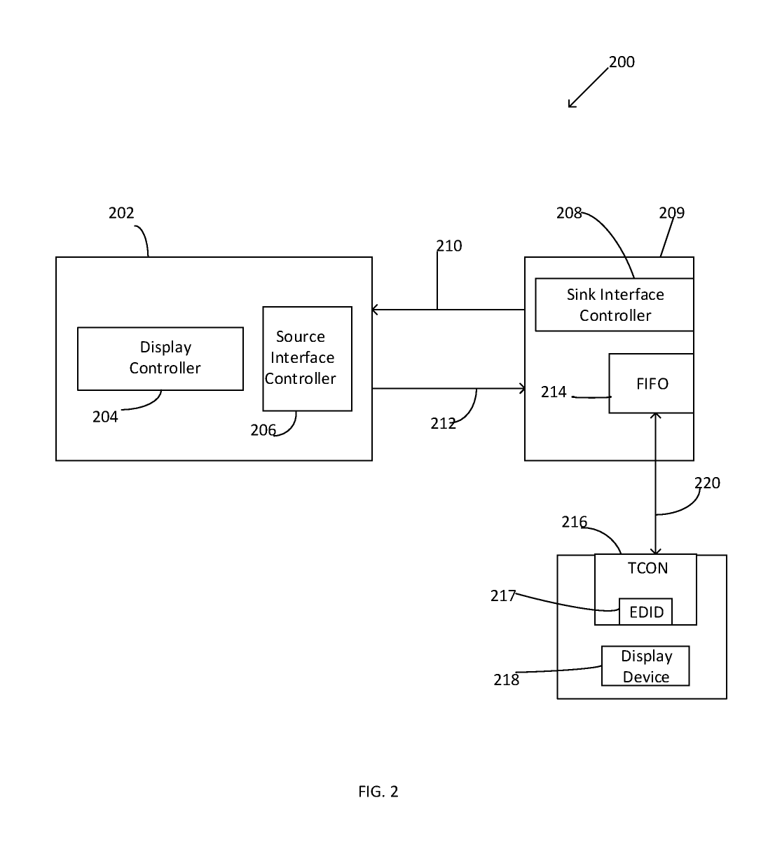

FIG. 2 is a block diagram illustrating an example system 200 that can be used to refresh a display device. In an embodiment the system 200 may comprise a portion of an embedded display device, such as an embedded display port (eDP) system 200, for example. An eDP system may be based on VESA DisplayPort Standards, such as eDP v.1.3, eDP v. 1.4 etc., and may comprise a high-performance external audio/visual (NV) interface, which may provide display resolutions of 4K and beyond, in some embodiments. In FIG. 2, the example system 200 may include a source device 202, such as a CPU and/or a GPU 202, which may include/be communicatively coupled with a display controller 204 and a source interface controller 206. A sink device 209, such as a display panel assembly, for example, may comprise a sink interface controller 208 that may be communicatively coupled/connected to the source device/interface controller 208 via uplink 210 and downlink 212. The sink interface controller 208 includes First In, First Out (FIFO) data buffer 214. The FIFO data buffer 214 is connected to a timing controller (TCON) 216 of display device 218 via connection 220. In some embodiments, the sink interface controller 208 and FIFO 214 can also be included in display device 218. The FIFO may comprise a refresh frame buffer (RFB), in some embodiments. An extended display identification data (EDID) 217 or a display port configuration data unit (DPCD) may be communicatively coupled to the FIFO 214.

In embodiments, sink interface controller 208 may send a request for video data via uplink 210. In some examples, the request includes display refresh rate. For example, the refresh rate may be 60 Hz or any suitable refresh rate. In response to the video data request, the source interface controller 206 can send bursts of video data via downlink 212. A burst, as used herein, is a unit of video data. For example, a video frame can be split into and sent as one or more bursts of video data. In some examples, the uplink 210 and downlink 212 can be an eDP main link (ML) physical layer PHY operating in dual simplex. However, any suitable physical layer with bi-directional capability and a threshold bandwidth support can be used. For example, MIPI D-PHY or M-PHY may also be used. In another example the uplink 210 may comprise a ML and the downlink may comprise an AUX and HUB of an embedded display system. In some examples, a link can be established using clock recovery and a symbol lock.

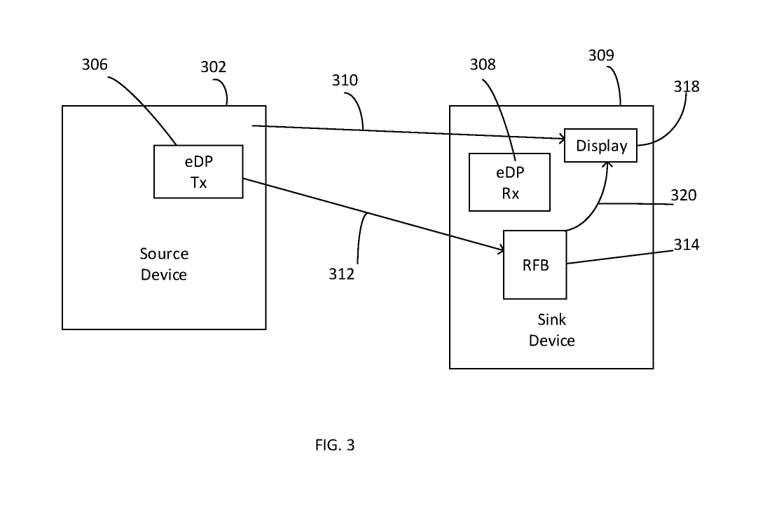

In some examples, the bursts of video data can be stored in a FIFO data buffer 214 of the sink interface controller 208. Alternatively, the bursts of video data can be stored in a line buffer or output laches of the sink interface controller 208. The size of the bursts can be negotiated as an interface initialization before any display refresh begins. The bursts of video data can then be used to refresh a display according to techniques described in FIGS. 3-8 below.

FIG. 3 is a communication diagram of an example system, such as an embedded display system for adaptive synchronization between source and sink devices at PSR2, without clock setting or DPCD. (In some cases, computer monitors may refresh their displays at a fixed frame rate. In gaming applications, a computer's CPU or GPU output frame rate may vary according to the rendering complexity of the image. If a display's refresh rate and a computer's render rate are not synchronized, visual artifacts, such as tearing or stuttering—can be seen by the user. Adaptive synchronization enables a display to dynamically match a GPU's rendering rate, on a frame-by-frame basis, to produce a smoother, low latency, user experience). The example system 300 includes a source device 302 comprising/communicatively coupled to a source interface controller 306, and a sink device 309 comprising/communicatively coupled to a sink interface controller 308. The source interface controller 306 is capable of communicating to the sink interface controller 208 with uplink and/or downlink 310, 312. Video data may be transferred between the source interface controller 206 and the sink interface controller 208.

In example system 300, the sink interface controller 208 can start a frame refresh. For example, the sink interface controller 308 can be enabled for PSR2, and may and may be enabled for low refresh rate (LRR) in the system and display, wherein EDID and/or DPCD configuration may be defined. The source device/system 302 may be capable of writing/sending a value of XXX high, through a communication link, such as uplink 312, to the buffer 314, and then to the display 318, in an embodiment. The source device 302 is further capable of writing/sending a value of XXX high, through a communication link, such as uplink 312, directly to the display 318, through communication link/connection 320, in an embodiment.

The system 300 may be applied to tablet, or mobile PC's, and can be used with liquid crystal display (LCD) or organic light emitting diode (OLED) displays. Prior art low refresh rate (LRR) at panel self-refresh 1 (PSR1) provide a means to lower display-related system power by allowing portions of the GPU and display interface to enter a low-power state during a static display image condition. MBO enabled is supported through dynamic refresh rate switching (DRRS) sync with display clock before entering PSR2 (selective update, SU). For example, prior art eDP enhances the PSR mechanisms by enabling updates to selected regions of the video frame in the TCON frame buffer. With eDP v1.3 (PSR1), the entire frame must be updated every time any portion of the image changes. With eDP v1.4 (PSR2), only the new portion of the frame requires updating. the GPU display interface remain active for a shorter duration, further reducing system power]. In prior art systems, TCON (timing controller) tech by TCON RFB (remote frame buffer) when no signal input from the source side may support PSR as well. However, LRR at PSR2 (selective update) with prior art displays cannot be supported due to selective update behavior. Even with extra DPCD (display port configuration data) support, PSR2 LRR only enabled by TCON RFB at static image. The embodiments herein use the eDP adaptive sync support to enable LRR at PSR2 to overcome existing display/TCON limitations at PSR2, for power benefit, and also to further apply the embodiments to wireless display use to further reduce data bit rate and power in various scenarios.

The system 300 implements adaptive sync to perform dynamical sync between Tx (source device 302 and Rx (sync device 309) at PSR2, without clock setting or DPCD. The frame rate (FR) can be done in vertical blanking period by (main stream attribute) MSA in eDP before PSR2. It can also help the data bit and potentially power due to dynamical FR (frame rate) sync between Tx/Rx without extra DPCD. The system 300 can operate at playback according to embodiments. The system 300 provides an efficient and convenient way to support LRR at PSR2 enabled for different uses. The system can also be applied to support dynamic frame rates when applied to wireless display use, to further save power and reduce data bit rate.

System 300 may need no special DPCD setting at PSR2 enabled, and may proceed with adaptive sync process of EDID/DPCD and MSA to enabled PSR2 LRR at PSR2, thus enabling static and playback dynamic synchronization. The system 300 enabled at PSR2 or PSR1 is estimated to provide 50 to 70 mW of display power saving per 10 Hz declination from 60 Hz, in some cases.

With dynamic adaptive sync of RR, the data bit rate may be reduced at playback and potentially improve the data bit rate, bandwidth, and power. The system 300 can be employed in eDP systems supporting adaptive sync and PSR2 related behavior. The systems included herein can offer power savings for mobile PC users and may be used with other battery-powered devices. In addition, wireless displays employing the embodiments described herein may enable low power and efficient processing of data, and can be used for 2 in 1 devices, simpler system configurations or travel friendly applications.

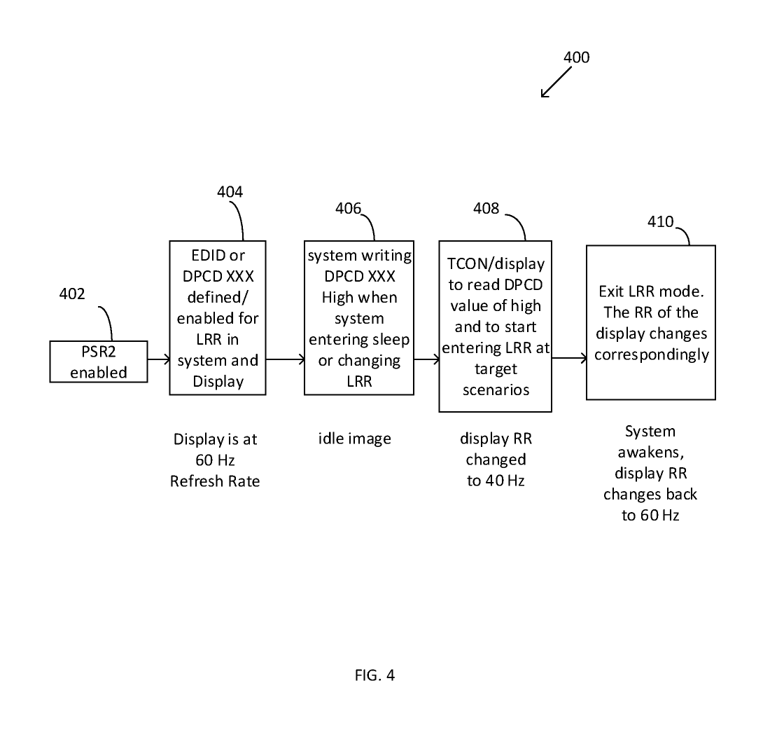

FIG. 4 is a process flow diagram illustrating an example method 400. The example method of FIG. 4 can be executed by the system of FIG. 2, for example. At step 402, PSR2 may be enabled. At step 404, EDID or DPCD (XXX) may be defined/enabled for LRR in the system and display. The display may be at 60 Hz refresh rate, for example. At step 406, the system writes to DPCD XXX High when the system enters sleep mode or changes to LRR. The system may be at an idle image. At step 408, TCON/display is to read the DPCD value of high and starts entering LRR at target scenarios, which may include refresh rates less than 60 HZ, such as 40 HZ, for example. The display RR may be changed to 40 Hz, in an embodiment. At step 410, the system exits LRR mode. The system awakens, and the RR changes back to 60 Hz, for example.

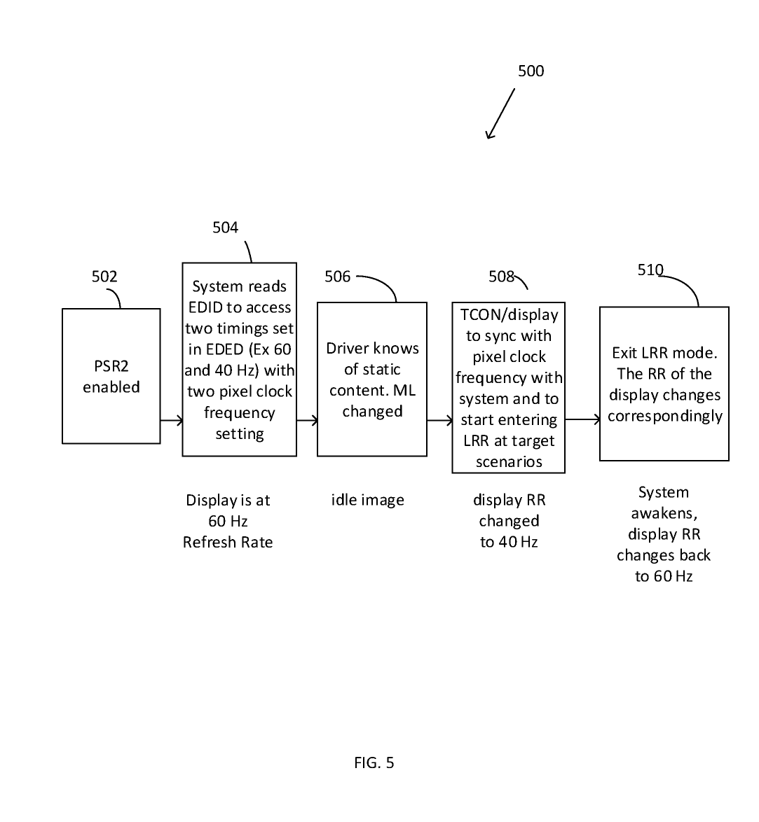

FIG. 5 is a process flow diagram illustrating an example method 500 that can be executed by the system of FIG. 2, for example. At step 502, PSR2 may be enabled. At step 504, the system reads EDID to access two timings set in EDID (Ex 60 and 40 Hz) with two pixel clock frequency settings for EDID or DPCD XXX, that may be defined/enabled for LRR in the system and display. The display may be at 60 Hz refresh rate, for example. At step 506, a driver reads of static content. Main link (ML) may be changed. At step 508, TCON/display to sync pixel clock frequency with system, and to start entering LRR at target scenarios, such as LRR refresh rates, which may include refresh rates less than 60 HZ, such as 40 HZ, for example. The display RR may be changed to 40 Hz, in an embodiment. At step 510, the system exits LRR mode. The system awakens, and the RR changes back to 60 Hz, for example.

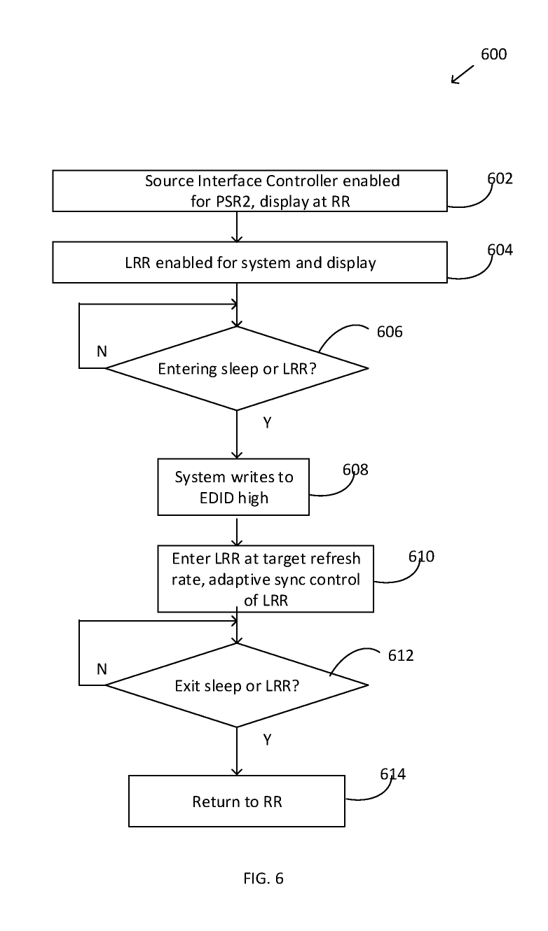

FIG. 6 is a process flow diagram illustrating an example method 600 that depicts computing device functionality for display burst data transfer. The example method of FIG. 6 can be executed by the system 200 in FIG. 2.

At block 602, the CPU 202 initializes the source interface controller 206. In an embodiment, the source Interface controller 206 is enabled for PSR2, and the display device may be at a refresh rate RR that may comprise 60 HZ, for example. The refresh rate prior to entering PRS2 may comprise 60 Hz, for example, for a liquid crystal display (LCD), in an embodiment.

At block 604, An extended display identification data (EDID) or DPCD may be defined/enabled for LRR in the system and display. For example, the range of LRR may be a range of refresh rates that a display device is capable of operating without screen flickering.

At block 606, the source interface controller 206 determines whether the system is at sleep or LRR. An idle image may be displayed at 60 Hz, for example.

At block 608, the source controller may write DPCD a high value upon entering sleep mode or LRR. If the source controller is not entering sleep or LRR, the source controller does not write a DPCD high value to EDID. The ML of the system may be off. For example, when the system is displaying a static image in a self-refresh mode, such as text, just a portion of the image changes, such as a flashing cursor, and PSR2 (partial frame update) enables the GPU to only send that part of the image instead of the whole video frame. Another important and complementary upgrade is the ability to change the GPU power state more quickly. Enabling the GPU/CPU to quickly exit and enter the low-power state to make a selective image update saves system power.

At block 610, the TCON/display may read the EDID/DPCD high value and enter LRR at target refresh rate scenarios. For example, the target refresh rate may be a rate that is lower than a previous rate, such as lower than 60 HZ, for example. A display device may operate at 60 Hz, for example, and have a target refresh rate of 40 Hz. By operating at a lower refresh rate, battery resources may be saved via less power consumption at the display device. The LRR at target RR may be dynamically synced with adaptive sync during PSR2, without clock setting or DPCD, between source and sink. The frame rate can be performed in the vertical blank period by MSA, in eDP, for example, before PSR2. Dynamic frame rate synchronization between source and sink devices without extra DPCD reduces data bit rate and power.

At block 612, the source interface controller 206 determines whether the system is to exit sleep mode or LRR. If not, the system remains in LRR with adaptive sync enabled.

At block 614, if the source controller is to exit PSR2, and awaken, the system leaves PSR2 and returns to the previous RR, such as returning from LRR dynamically control of adaptive sync, to the previous refresh rate of 60 Hz, for example.

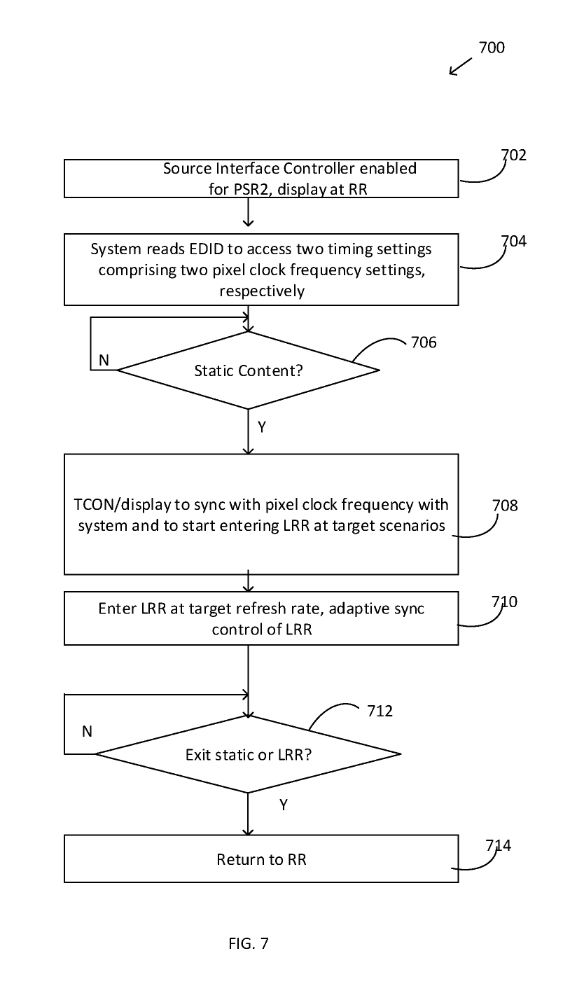

FIG. 7 is a process flow diagram illustrating an example method 700 that depicts computing device functionality for display burst data transfer. The example method of FIG. 7 can be executed by the source interface controller 206 of CPU 202 in FIG. 2, for example.

At block 702, the CPU 202 initializes the source interface controller 206. In an embodiment, the source interface controller 206 is enabled for PSR2, and the display device may be at a RR that may comprise 60 HZ, for example. The refresh rate prior to entering PRS2 may comprise 60 Hz, for example, for a liquid crystal display (LCD), in an embodiment.

At block 704, the source controller may read EDID to access two timing settings comprising two pixel clock frequency settings, respectively. For example, the two EDID settings may comprise 60 and 40 Hz, respectively.

At block 706, the source interface controller 206 determines whether the system is at static content, wherein ML may change, such as at sleep mode or LRR. An idle image may be displayed at 60 Hz refresh rate, for example. If no static content determined, the source controller remains at 60 Hz RR.

At block 708, TCON/display syncs pixel clock frequency with the source controller and enters LRR at target scenarios. The target scenarios may comprise a LRR, which may comprise refresh rates of 40 HZ, or below.

At block 710, the TCON may enter LRR at target refresh rate, with adaptive sync control of LRR. By operating at a lower refresh rate, battery resources may be saved via less power consumption at the display device. The LRR at target RR may be dynamically synced with adaptive sync during PSR2, without clock setting or DPCD, between source and sink. The frame rate can be performed in the vertical blank period by MSA, in eDP, for example, before PSR2. Dynamic FR sync between source and sink devices without extra DPCD reduces data bit and power.

At block 712, the source interface controller 206 determines whether the system is to exit sleep/static mode or LRR. If not, the system remains in LRR with adaptive sync enabled.

At block 714, if the source controller is to exit PSR2, and awaken, the system leaves PSR2 and returns to the previous RR, such as returning from LRR dynamically control of adaptive sync, to the previous refresh rate of 60 Hz, for example.

This process flow diagram is not intended to indicate that the blocks of the method 700 are to be executed in any particular order, or that all of the blocks are to be included in every case. Further, any number of additional blocks not shown may be included within the method 700, depending on the details of the specific implementation.

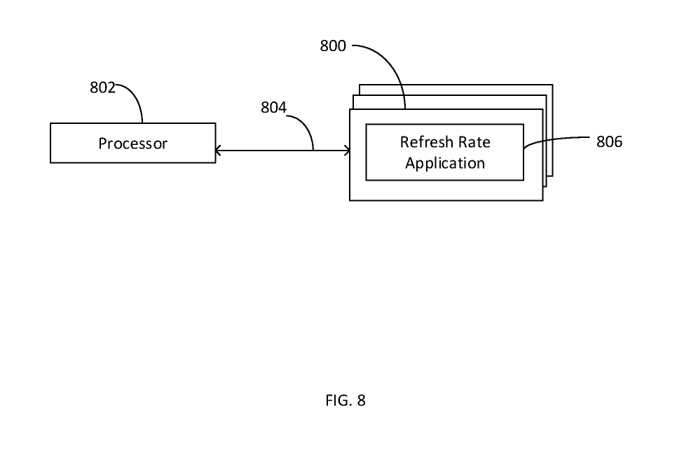

FIG. 8 is a block diagram showing computer readable media 800 that store code for discovery of devices. The computer readable media 800 may be accessed by a processor 802 over a computer bus 804. Furthermore, the computer readable medium 800 may include code configured to direct the processor 802 to perform the methods described herein. In some embodiments, the computer readable media 800 may be non-transitory computer readable media. In some examples, the computer readable media 800 may be storage media. However, in any case, the computer readable media do not include transitory media such as carrier waves, signals, and the like.

The block diagram of FIG. 8 is not intended to indicate that the computer readable media 800 are to include all of the components shown in FIG. 8. Further, the computer readable media 800 may include any number of additional components not shown in FIG. 8, depending on the details of the specific implementation.

The various software components discussed herein may be stored on one or more computer readable media 800, as indicated in FIG. 11. For example, a refresh rate application 806 may be configured to cause the computing device to: send, via a processor, a EDID value of high at PSR2, wherein a display controller responds to the high value is by entering into LRR, wherein the LRR is dynamically controlled.

In some examples, the refresh rate application 806 may initialize a source controller interface. For example, the refresh rate application 806 may be configured to enabled the source controller for PSR2, wherein the display may be at a refresh rate of about 60 Hz, for example. The refresh rate application 806 can also include instructions to enter sleep mode for a predetermined interval of time based on a target refresh rate. In some examples, the refresh rate application 806 can include instructions to synchronize a video data transfer start to a display internal refresh start. The refresh rate application 806 may also include instructions to resume a video data transfer.

### Examples

Example 1 is a system comprising: a source interface controller enabled for panel self-refresh 2 (PSR2), and enabled for low refresh rate (LRR); a display controller to read a value of high from the source controller, and to enter a LRR at a target refresh rate (RR) when the source interface controller enters a low refresh rate (LRR) or sleep mode, wherein the RR is dynamically controlled during PSR2.

Example 2 includes the system of example 1, wherein the target LRR comprises about 40 Hz or below.

Example 3 include the system of example 1, wherein a sink interface controller coupled to the display controller comprises a First In, First Out (FIFO) data buffer, the FIFO to receive a video burst from the source interface controller and to send the video burst to a display device.

Example 4 includes the system of example 1, wherein the system comprises an embedded display port (eDP) system, and the LRR is controlled by adaptive sync.

Example 5 includes the system of example 1, wherein the source controller is to read two timing settings and two pixel clock frequency settings of the extended display identification data (EDID).

Example 6 includes the system of example 1, the display controller to receive a video burst via the source interface controller of a graphics processing unit (GPU).

Example 7 includes the system of example 1, the system comprising a mobile device.

Example 8 is a method for dynamically controlling refresh rates at PSR2, comprising: sending, via a source interface controller enabled for PSR2, a display port configuration data (DPCD) value of high to an EDID, to include a low refresh rate target value of a display device; receiving, via the sink interface controller, the DPCD high value; and entering, via the sink interface controller, a LRR at target RR when the source interface controller enters LRR or sleep mode, wherein the RR is dynamically controlled during PSR2.

Example 9 includes the method of example 8, wherein high value is enabled for LRR in source controller and sink controller.

Example 10 includes the method of example 8, further comprising the source interface controller sending the high value to one of a DPCD or a EDID when source interface controller enters LRR or sleep mode.

Example 11 includes the method of claim 10, further comprising the sink interface controller to read the EDID value of high.

Example 12 includes the method of example 8, further comprising wherein adaptive sync dynamically syncs refresh rate between sink and source controllers at PSR2 without clock setting or DPCD.

Example 13 includes the method of example 12, further comprising wherein frame refresh is performed during V blank before entering PSR2 by main stream attribute (MSA).

Example 14 includes the method of example 8, further comprising wherein adaptive sync dynamically changes refresh rates during PSR2.

Example 15 is at least one computer readable medium for controlling refresh rates having instructions stored therein that, in response to being executed on a computing device, cause the computing device to: send, via a processor, an EDID value of high at PSR2, wherein a display controller responds to the high value by entering into a LRR, and wherein the LRR is dynamically controlled.

Example 16 includes the at least one computer readable medium of example 15, further comprising instructions to initialize a source controller interface to include PSR2 enable and an EDID high value.

Example 17 includes the at least one computer readable medium of example 16, further comprising instructions to dynamically changing refresh rates during PSR2 using adaptive synchronization.

Example 18 includes the at least one computer readable medium of example 15, further comprising instructions to sleep for a predetermined interval of time based on a target refresh rate.

Example 19 includes the at least one computer readable medium of example 15, further comprising instructions to synchronize a LRR during PRS2.

Example 20 includes the at least one computer readable medium of claim 19, further comprising instructions to synchronize without clock or DPCD settings.

Example 21 is an apparatus for controlling refresh rates, comprising: a sink interface controller enabled for PSR2 to read an EDID or DPCD from a source interface controller; a display controller to read a DPCD value of high, and to enter a LRR at target RR when a source interface controller enters LRR or sleep mode; and a timing controller to dynamically sync a refresh rate of the apparatus during PSR2.

Example 22 includes the apparatus of example 21, the timing controller further comprising a frame buffer, the frame buffer to store frames used in a panel self-refresh (PSR).

Example 23 includes the apparatus of example 21, wherein the source controller is to read from the EDID two timings set in EDED and two pixel clock frequency settings.

Example 24 includes the apparatus of claim 23, a TCON to sync the pixel clock frequency settings with the two timing settings and to enter LRR at target refresh rate.

Example 25 includes the apparatus of example 21, wherein the display device comprises a wireless display.

Although the foregoing description has specified certain steps and materials that may be used in the methods of the embodiments, those skilled in the art will appreciate that many modifications and substitutions may be made. Accordingly, it is intended that all such modifications, alterations, substitutions and additions be considered to fall within the spirit and scope of the embodiments as defined by the appended claims.

1. A system comprising:
a source interface controller enabled for panel self-refresh 2 (PSR2), and enabled for low refresh rate (LRR), wherein the source interface controller is coupled with an embedded display port (eDP), the eDP having adaptive synchronization capabilities, wherein the eDP is capable of dynamically synchronizing between a source device and a sink device; and
a display controller to read an extended display identification data (EDID) value of high from the source interface controller, and to enter a LRR at a target refresh rate (RR) when the source interface controller enters a low refresh rate (LRR) mode or a sleep mode, wherein the RR is capable of being dynamically controlled during PSR2 while in a playback mode.

2. The system of claim 1, wherein the target LRR comprises about 40 Hz or below.

3. The system of claim 1, further comprising wherein the display controller comprises a sink interface controller coupled to the source interface controller, wherein the eDP is capable of dynamically synchronizing between the display controller and the source interface controller without a clock setting or an EDID value.

4. The system of claim 1, wherein the LRR is capable of being controlled by the dynamic synchronization of the eDP.

5. The system of claim 1, wherein the source interface controller is to read two EDID timing settings and to read two pixel clock frequency settings.

6. The system of claim 1, wherein the display controller is to synchronize with the pixel clock frequency of the system interface controller of a graphics processing unit (GPU), and is to enter LRR at a target RR.

7. The system of claim 1, wherein the system comprises a portion of a mobile device.

8. A method for dynamically controlling refresh rates during panel self refresh 2 (PSR2), comprising:
sending, via a source interface controller enabled for PSR2, an extended display identification data (EDID) high value, to include a low refresh rate (LLR) target value of a display device, to a sink interface controller;
receiving, via the sink interface controller, the EDID high value; and
entering, via the sink interface controller, a LRR at a target refresh rate (RR) when the source interface controller enters LRR or a sleep mode, wherein the target RR is dynamically controlled during PSR2 by adaptive synchronization of an embedded display port (eDP) port coupled with the source interface controller, during a playback mode.

9. The method of claim 8, wherein the high value is enabled for LRR in the source interface controller and the sink interface controller.

10. The method of claim 8, further comprising the source interface controller sending the high value to the EDID value when the source interface controller enters LRR or sleep mode.

11. The method of claim 10, further comprising the sink interface controller reading the EDID value of high.

12. The method of claim 8, wherein the adaptive synchronization of the eDP dynamically synchronizes the refresh rate between the sink and the source controllers at PSR2 without clock setting or an EDID.

13. The method of claim 12, further comprising performing frame refresh during V blank before entering PSR2 by main stream attribute (MSA).

14. The method of claim 8, further comprising dynamically changing refresh rates during PSR2 by performing adaptive synchronization.

15. A non-transitory computer readable medium with instructions stored thereon, that when executed by a processor, perform the steps comprising:
initializing a source controller interface to include panel self refresh 2 (PSR2) enable and an extended display identification data (EDID) high value; and
sending, via the processor, an EDID value of high at PSR2 to a display controller, wherein the display controller responds to the high value by entering into a low refresh rate (LRR), and wherein the LRR is dynamically controlled by adaptive synchronization during playback mode while in PSR2.

16. (canceled)

17. The non-transitory computer readable medium of claim 15, further comprising dynamically changing refresh rates during PSR2 using adaptive synchronization.

18. The non-transitory computer readable medium of claim 15, further comprising sleeping for a predetermined interval of time based on a target refresh rate.

19. The non-transitory computer readable medium of claim 15, further comprising dynamically synchronizing a LRR during PRS2 between the display controller and the source interface controller.

20. The non-transitory one computer readable medium of claim 19, further comprising synchronizing without clock or EDID settings.

21. An apparatus for controlling refresh rates, comprising:
a sink interface controller enabled for panel self refresh 2 (PSR2) to read an extended display identification data (EDID) from a source interface controller, the source interface controller enabled for PSR2;
a display controller to read an EDID value of high, and to enter a low refresh rate (LRR) at a target refresh rate (RR) when a source interface controller enters LRR or sleep mode; and
a timing controller to dynamically synchronize the target RR of a display coupled to the display controller during PSR2, wherein the target RR is capable of being dynamically synchronized during a playback mode while in PSR2.

22. The apparatus of claim 21, wherein the timing controller further comprising a frame buffer, the frame buffer to store frames used in a PSR2.

23. The apparatus of claim 21, the source interface controller to read from the EDID two timings set in the EDID and two pixel clock frequency settings.

24. The apparatus of claim 23, a wherein the timing controller is to synchronize the pixel clock frequency settings with the two timing settings and to enter LRR at target refresh rate.

25. The apparatus of claim 21, further including a wireless display device coupled to the display controller.
